(19) United States
(12) Patent Application Publication
(10) Pub. No.: US 2013/0183986 A1
(43) Pub. Date: Jul. 18, 2013

(54) METHOD FOR DETERMINING TRANSMIT POWER OF SMALL BASE STATION AND CONTROL DEVICE USING THE SAME

(71) Applicants: Byoung Seong PARK, Bupyeong-gu (KR); Jung Seung LEE, Uiwang-si (KR)

(72) Inventors: Byoung Seong PARK, Bupyeong-gu (KR); Jung Seung LEE, Uiwang-si (KR)

(21) Appl. No.: 13/348,815

(22) Filed: Jan. 12, 2012

(51) Int. Cl. H04W 52/16

(52) U.S. Cl. 455/446

(57) ABSTRACT

A method for determining transmit power of a small base station according to its installed position and changes in interference environments created by neighboring outdoor base stations and small base stations and a control device using the determination method. In one embodiment, a control device interacting with a control device interacting with a mobile telecommunication system having at least one outdoor base station and at least one small base station located in the area under the control of the outdoor base station. The control device is configured to determine transmit power of the at least one small base station in consideration of interference components generated by the at least one outdoor base station.

### TECHNICAL FIELD

The present invention generally relates to a mobile telecommunication system and a method for determining transmit power of a small base station, and more particularly to a method for determining transmit power of a small base station according to its installed position and changes in interference environments created by neighboring outdoor base stations and small base stations and a control device using the determination method.

### BACKGROUND

Recently, wireless data services through code division multiple access (CDMA) 2000, evolution data only (EV-DO), wideband CDMA (WCDMA) and wireless local area networks (WLANs) have been commercialized. Thus, residential use of mobile phones and the demand for mobile data at home have increased steadily. To keep up with such trend, a method for providing mobile telecommunication services by installing a small base station indoors has been proposed so as to access a core network of mobile telecommunications through an indoor broadband network. Such a small base station may include a femto base station, a pico base station, a mirco base station, an indoor base station and a relay for use in cell expansion.

The small base station has a fixed transmit power regardless of its location so that the transmit power thereof is not automatically adjusted according to changes in interference environments created by outdoor base stations and other small base stations, which are located near the small base station.

In general, the fixed transmit power used in the small base station is high enough to secure a service area for a user of the small base station. The power can be adjusted manually or through a management server depending on the link performance.

In such a small base station, the transmit power cannot reflect the surrounding interference environments to thereby cause a difference in the link performance depending on the installed position of the small base station. As a consequence, the small base station has difficulty in providing stable and reliable service. Further, when the power of the small base station is set excessively high, interference to a user equipment of a neighboring small base station increases, resulting in performance degradation of the neighboring small base station.

### SUMMARY

The present disclosure provides some embodiments of a method for determining transmit power of a small base station according to its installed position and changes in interference environments created by neighboring outdoor base stations and small base stations and a control device using the determination method.

According to one embodiment, a control device interacts with a mobile telecommunication system having at least one outdoor base station and at least one small base station located in the area under the control of the outdoor base station. The control device is configured to determine transmit power of the at least one small base station in consideration of interference components generated by the at least one outdoor base station.

According to another embodiment, there is a method for determining transmit power of at least one small base station in a mobile telecommunication system, the mobile telecommunication system having at least one outdoor base station and the at least one small base station located in the area under the control of the at least one outdoor base station. The method includes: receiving information on first interference components generated by the at least one outdoor base station; and determining the transmit power of the at least one small base station based on the information on the first interference components.

### BRIEF DESCRIPTION OF THE DRAWINGS

FIG. 1 is a diagram showing a mobile telecommunication system in accordance with one embodiment.

FIG. 2 is a graph showing transmit powers determined in accordance with one embodiment.

FIG. 3 is a graph showing a performance difference according to a transmit power determining method in accordance with one embodiment.

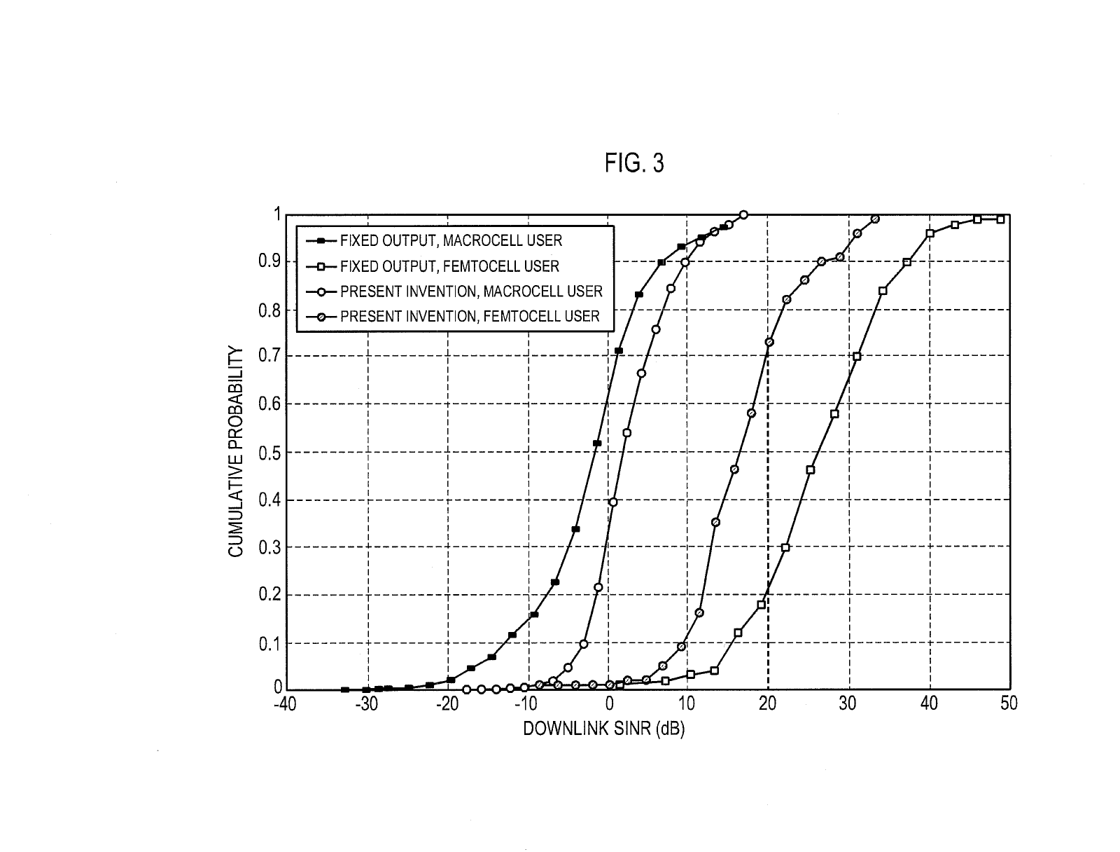

### DETAILED DESCRIPTION

Embodiments of the present disclosure will now be described in detail with reference to the drawings. In the following, detailed descriptions of well-known functions and constructions will be omitted to avoid obscuring the essence of the present disclosure.

In a mobile telecommunication system, a number of subscriber equipments and a number of small base stations use the same frequency channel at the same time. The use of the same frequency channel causes interference among simultaneous callers and small base stations. Accordingly, each small base station is required to properly control its transmit power in order to improve system efficiency and call quality. In one embodiment, the small base station may include a femto base station, a pico base station, a mirco base station, an indoor base station, a relay for use in cell expansion and the like. In the drawings, a cell of an outdoor base station is a macrocell and a cell of the small base station is a femtocell by way of example.

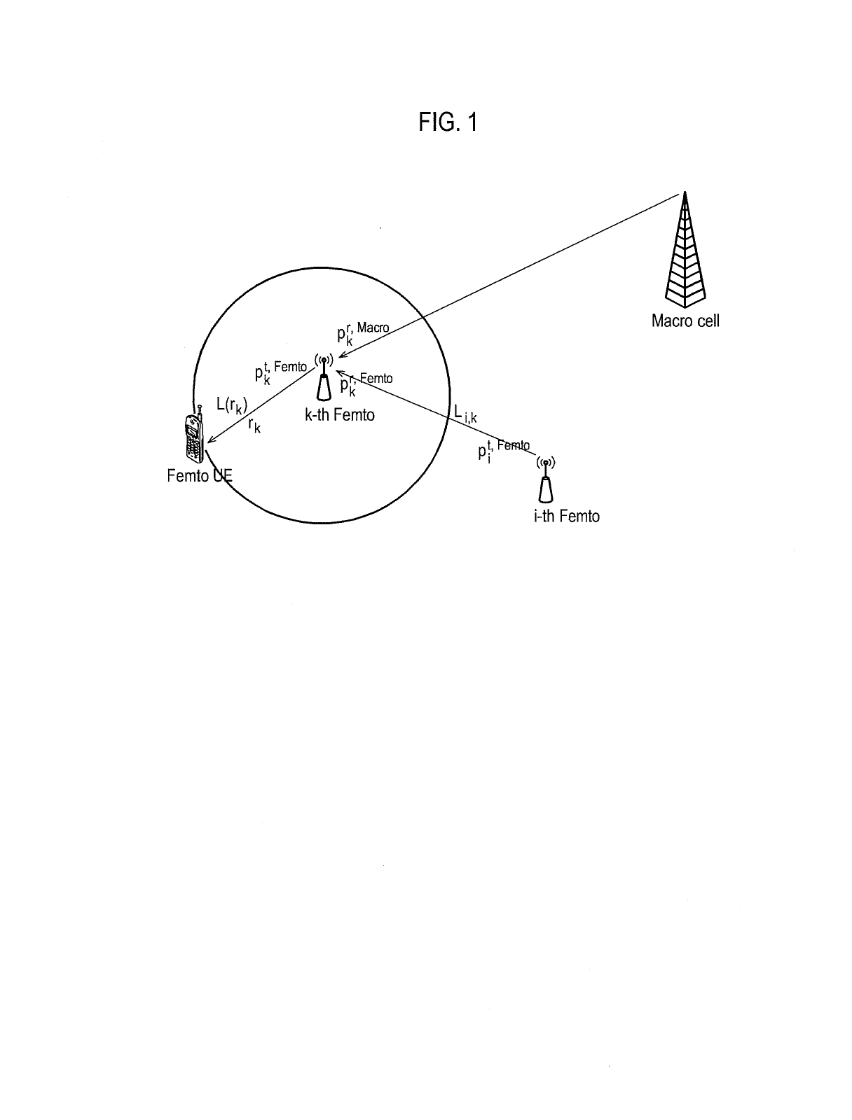

FIG. 1 is a diagram showing a mobile telecommunication system in accordance with one embodiment. In one embodiment, the transmit power of the small base station may be determined by using interference components generated by a higher-level outdoor base station including a specific small base station in its coverage and interference components generated by other small base stations, wherein the interference components are measured and predicted in the specific small base station.

If a maximum transmit power of a k^{th} small base station is Pₘₐₓ^{t,Femto}, a transmit power Pₖ^{t,Femto} of the k^{th} small base station may be determined by calculating ωₖ of the following equation 1, which uses the relationship with respect to multiple small base stations.

pₖ^{t,Femto}=pₘₐₓ^{t,Femto}·ωₖ0≦ωₖ≦1 Eq. 1

If there exist as many as N small base stations which are necessary for determining the transmit power of the k^{th} small base station, the transmit powers of the N small base stations may be calculated in consideration of a matrix equation of the following equation 2.

ω=A⁻¹b Eq. 2

In the above equation 2, ω, A and b may represent the following matrix equations.

$$ω = [ \begin{matrix}{ω}_{1} \\ {ω}_{2} \\ {ω}_{3} \\ ⋮ \\ {ω}_{N}\end{matrix} ]$$

$$A = [ \begin{matrix}\frac{L ( {r}_{1} )}{{SINR}_{reg}} & - α {L}_{2 , 1} & - α {L}_{3 , 1} & … & - α {L}_{N , 1} \\ - α {L}_{1 , 2} & \frac{L ( {r}_{2} )}{{SINR}_{reg}} & - α {L}_{3 , 2} & … & - α {L}_{N , 2} \\ - α {L}_{1 , 3} & - α {L}_{2 , 3} & \frac{L ( {r}_{3} )}{{SINR}_{reg}} & … & - α {L}_{N , 3} \\ ⋮ & ⋮ & ⋮ & ⋱ & ⋮ \\ - α {L}_{1 , N} & - α {L}_{2 , N} & - α {L}_{3 , N} & … & \frac{L ( {r}_{N} )}{{SINR}_{reg}}\end{matrix} ] and$$

$$b = \frac{1}{{p}_{max}^{t , Femto}} [ \begin{matrix}{p}_{1}^{γ , Macro} + {p}_{1}^{γ , Thermal} \\ {p}_{2}^{γ , Macro} + {p}_{2}^{γ , Thermal} \\ {p}_{3}^{γ , Macro} + {p}_{3}^{γ , Thermal} \\ ⋮ \\ {p}_{N}^{γ , Macro} + {p}_{N}^{γ , Thermal}\end{matrix} ]$$

wherein Pₖ^{t,Femto} represents the interference components generated by the neighboring small base stations, which are measured or predicted by the k^{th} small base station, Pₖ^{r,Macro} represents the interference components generated by the high-level outdoor base station including the k^{th} small base station in its coverage, Pₖ^{r,Thermol} represents noise components generated by a user equipment for which a mobile telecommunication service is provided by the k^{th} small base station, SINR_{req} represents a signal to interference and noise ratio necessary for securing a required link performance, and L_{i,k} represents a path loss between the k^{th} small base station and an i^{th} an small base station.

If the path loss in a service radius rₖ which the k^{th} small base station aims to reach is L(rₖ) and the signal to interference and noise ratio necessary for securing the required link performance to obtain SINRₖ^{MS} predicted in the position of the user equipment for which the mobile telecommunication service is provided by the k^{th} small base station is SINR_{req}, the transmit power of the k^{th} small base station Pₖ^{t,Femto} may be calculated by deriving equation 4 from equation 3 both shown below.

$$\begin{matrix}{SINR}_{k}^{MS} ≅ \frac{{p}_{k}^{t , Femto} \cdot L ( {r}_{k} )}{{p}_{k}^{γ , Femto} + {p}_{k}^{γ , Macro} + {p}_{k}^{γ , Thermal}} \geq {SINR}_{reg} \\ k = 1 , 2 , … , N & Eq . 3 \\ {p}_{k}^{t , Femto} = \frac{{SINR}_{reg}}{L ( {r}_{k} )} ( α \cdot {p}_{k}^{γ , Femto} + {p}_{k}^{γ , Macro} + {p}_{k}^{γ , Thermal} ) & Eq . 4\end{matrix}$$

In the above equation 4, α is a coefficient for the interference amount by the neighboring small base stations, which may have a value greater than or equal to 0 and less than or equal to 1. The transmit power of the specific small base station may be less affected by the neighboring small base stations by reducing a ratio of the interference components generated by the neighboring small base stations to the interference components generated by the high-level outdoor base station including the specific small base station in its coverage, among the interference components received by the specific small base station.

The interference components by the neighboring small base stations may be expressed by using the path L_{i,k} between the k^{th} small base station and the i^{th} small base station, as follows.

$$\begin{matrix}{p}_{k}^{γ , Femto} = {\sum }_{{i = 1}_{i \neq k}}^{N} {p}_{i}^{t , Femto} \cdot {L}_{i , k} \\ = {\sum }_{{i = 1}_{i \neq k}}^{N} {p}_{max}^{t , Femto} \cdot {ω}_{i} \cdot {L}_{i , k}\end{matrix} \qquad Eq . 5$$

Equations 4 and 5 may be developed into the following equation 6.

$$\frac{L ( {r}_{k} )}{{SINR}_{reg}} \cdot {ω}_{k} - α \cdot {\sum }_{{i = 1}_{i \neq k}}^{N} {L}_{i , k} \cdot {ω}_{i} = \frac{{p}_{k}^{γ , Macro} + {p}_{k}^{γ , Thermal}}{{p}_{max}^{t , Femto}} \qquad Eq . 6$$

wherein Pₖ^{r,Thermol} is the noise components generated by the user of the k^{th} small base station.

Equation 6 may be expressed as a matrix equation such as the following equation 7 for the N small base stations.

$$[ \begin{matrix}\frac{L ( {r}_{1} )}{{SINR}_{reg}} & - α {L}_{2 , 1} & - α {L}_{3 , 1} & … & - α {L}_{N , 1} \\ - α {L}_{1 , 2} & \frac{L ( {r}_{2} )}{{SINR}_{reg}} & - α {L}_{3 , 2} & … & - α {L}_{N , 2} \\ - α {L}_{1 , 3} & - α {L}_{2 , 3} & \frac{L ( {r}_{3} )}{{SINR}_{reg}} & … & - α {L}_{N , 3} \\ ⋮ & ⋮ & ⋮ & ⋱ & ⋮ \\ - α {L}_{1 , N} & - α {L}_{2 , N} & - α {L}_{3 , N} & … & \frac{L ( {r}_{N} )}{{SINR}_{reg}}\end{matrix} ] [ \begin{matrix}{ω}_{1} \\ {ω}_{2} \\ {ω}_{3} \\ ⋮ \\ {ω}_{N}\end{matrix} ] = \frac{1}{{p}_{max}^{t , Femto}} [ \begin{matrix}{p}_{1}^{γ , Macro} + {p}_{1}^{γ , Thermal} \\ {p}_{2}^{γ , Macro} + {p}_{2}^{γ , Thermal} \\ {p}_{3}^{γ , Macro} + {p}_{3}^{γ , Thermal} \\ ⋮ \\ {p}_{N}^{γ , Macro} + {p}_{N}^{γ , Thermal}\end{matrix} ] \qquad Eq . 7$$

Since the small base stations mutually influences one another by interference, determination of the transmit power of the specific small base station does not ensure optimization of the entire mobile telecommunication system. This is because the determined transmit power of the specific small base station affects other small base stations. Therefore, a control device (not shown) capable of receiving and managing information on the interference states of the N small base stations (that is, the control device being connected with the N small base stations) may determine the transmit powers for the N small base stations at the same time. The determination of the transmit powers for the N small base stations may be performed when the system is initially installed or when the system is rebooted, or periodically in consideration of the surrounding channel statuses (e.g., when a small base station is newly installed or power off of some small base station occurs in the surroundings). The control device could be a stand alone device, part of the mobile telecommunication system, part of the small base station or part of the outdoor base station.

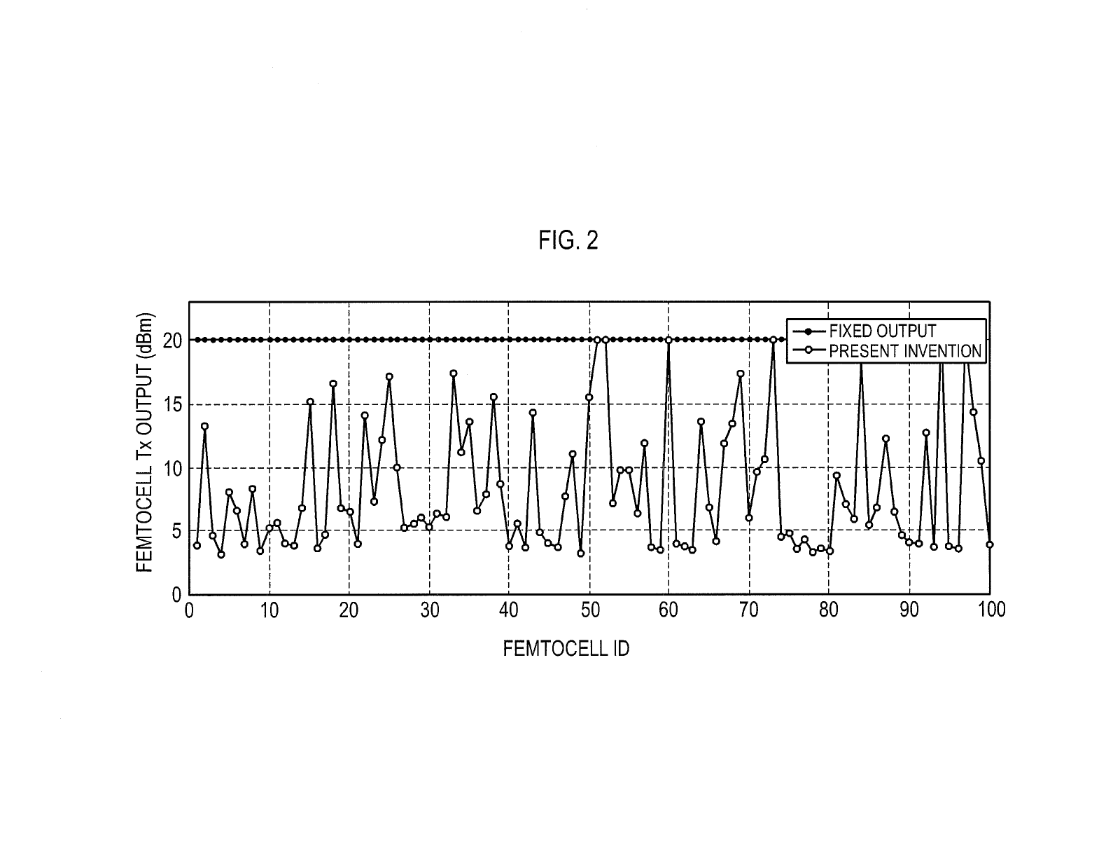

In one embodiment, when one hundred small base stations with a size of 10 m×10 m are randomly arranged within a coverage of the outdoor base station with a radius of 1 km, the transmit power levels of the small base stations determined by using the equations 1 to 7 are as shown in FIG. 2. At this time, Pₘₐₓ^{t,Femto}, rₖ and SINR_{req} are set to be Pₘₐₓ^{t,Femto}=20 dBm, rₖ=5 m, SINR_{req}=10 dB, respectively. As such, the transmit powers of the one hundred small base stations may be determined according to the surrounding interference environments which may vary depending upon the locations of the small base stations.

While the above-described methods are explained with reference to certain exemplary embodiments, the methods can also be realized as a computer readable code in a computer readable recording medium. The computer readable recording medium may include any form of recording apparatus as long as the recording apparatus can store data readable by a computer system. By way of example, the computer readable recording medium may be a ROM, a RAM, a CD-ROM, a magnetic tape, a floppy disk, an optical data storage unit or the like. The computer readable recording medium may also be realized in the form of a carrier wave (e.g., transmission via internet). The computer readable recording medium may be distributed in the computer system connected by a network, where the computer readable code can be stored and executed in a distribution manner. A functional program and, a code and its segments for realizing the above-described embodiments can be easily implemented by programmers skilled in the art.

As used in this application, entities for executing the actions can refer to a computer-related entity, either hardware, a combination of hardware and software, software, or software in execution. For example, an entity for executing an action can be, but is not limited to being, a process running on a processor, a processor, an object, an executable, a thread of execution, a program, and a computer. By way of illustration, both an application running on an apparatus and the apparatus can be an entity. One or more entities can reside within a process and/or thread of execution and an entity can be localized on one apparatus and/or distributed between two or more apparatuses.

The program for realizing the functions can be recorded in the apparatus can be downloaded through a network to the apparatus and can be installed in the apparatus from a computer readable storage medium storing the program therein. A form of the computer readable storage medium can be any form as long as the computer readable storage medium can store programs and is readable by an apparatus such as a disk type ROM and a solid-state computer storage media. The functions obtained by installation or download in advance in this way can be realized in cooperation with an OS (Operating System) in the apparatus.

While certain embodiments have been described, these embodiments have been presented by way of example only, and are not intended to limit the scope of the disclosures. Indeed, the novel methods and systems described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A control device interacting with a mobile telecommunication system having at least one outdoor base station and at least one small base station located in the area under the control of the outdoor base station, wherein the control device is configured to determine transmit power of the at least one small base station in consideration of interference components generated by the at least one outdoor base station.

2. The control device of claim 1, wherein the control device is configured to determine the transmit power of the at least one small base station in consideration of the interference components generated by the at least one outdoor base station and interference components generated by other small base stations.

3. The control device of claim 2, wherein the control device is configured to determine the transmit power of the at least one small base station in consideration of path losses between the at least one small base station and said other small base stations and a signal to interference and noise ratio required for securing a targeted link performance of the at least one small base station.

4. The control device of claim 3, wherein the transmit power of the at least one small base station is set when the system is initially installed or when the system is rebooted, or periodically in consideration of the channel statuses.

5. The control device of claim 4, wherein the transmit power of the at least one small base station is less affected by said other small base stations by reducing a ratio of the interference components generated by said other small base stations to the interference components generated by the at least one outdoor base station including the at least one small base station in its coverage.

6. A method for determining transmit power of at least one small base station in a mobile telecommunication system, the mobile telecommunication system having at least one outdoor base station and the at least one small base station located in the area under the control of the at least one outdoor base station, the method comprising:
receiving information on first interference components generated by the at least one outdoor base station, and
determining the transmit power of the at least one small base station based on the information on the first interference components.

7. The method of claim 6, further comprising receiving information on second interference components generated by other small base stations prior to the determining of the transmit power of the at least one small base station,
wherein the determining of the transmit power of the at least one small base station comprises determining the transmit power of the at least one small base station in consideration of the information on the first interference components and the information on the second interference components.

8. The method of claim 7, wherein the determining of the transmit power of the at least one small base station further comprises determining the transmit power of the at least one small base station based on path losses between the at least one small base station and said other small base stations and a signal to interference and noise ratio required for securing a targeted link performance of the at least one small base station.

9. The method of claim 8, wherein the determination of the transmit power of the at least one small base station is performed when the system is initially installed or when the system is rebooted, or periodically in consideration of the channel statuses.

10. The method of claim 9, wherein the power of the at least one small base station is less affected by said other small base stations by reducing a ratio of the interference components generated by said other small base stations to the interference components generated by the at least one outdoor base station including the at least one small base station in its coverage.
